(19) United States
(12) Patent Application Publication
(10) Pub. No.: US 2024/0173825 A1
(43) Pub. Date: May 30, 2024

(54) OPEN-ENDED RATCHET WRENCH

(71) Applicant: Nicholas Peterson, Chandler, AZ (US)

(72) Inventor: Nicholas Peterson, Chandler, AZ (US)

(21) Appl. No.: 17/994,206

(22) Filed: Nov. 25, 2022

(51) Int. Cl. B25B 13/06; B25B 13/46

(52) U.S. Cl. CPC B25B 13/06; B25B 13/462

(57) ABSTRACT

An open-ended ratchet wrench includes a wrench body, an open-ended wrench head coupled on a first distal end of the wrench body, and a handle disposed on a second distal end of the wrench body. The open-ended ratchet wrench includes a ratchet mechanism such that the open-ended wrench head is capable of continuous rotational motion in only one direction. The wrench head can be easily removed and replaced by another such wrench head of a different size from a set of wrench heads. The tool is particularly useful in places where a socket wrench would not fit.

### TECHNICAL FIELD

The present disclosure relates generally to hand tools, and more particularly to an open-ended ratchet wrench.

### BACKGROUND

Ratcheting wrenches are commonly used hand tools that allow for quickly tightening or removing fasteners, usually bolts or nuts. The ratcheting mechanism permits the user to turn the wrench handle in only one direction to apply torque to a fastener. Moving the handle in the opposite direction will not move the fastener, but allows the handle to be repositioned for another turn. Notably, the user does not have to remove the wrench head from the fastener, but merely repeat push-pull motions (or pull-push motions). The invention of the ratcheting socket wrench is attributed to J. J. Richardson, disclosed in U.S. Pat. No. 38,914, issued Jun. 16, 1863.

Although ratcheting socket wrenches are useful, one cannot always be used. For example, there may not be enough clearance to fit the socket over the bolt or nut head. This situation is quite common when working on complex mechanical devices such as automobiles or large industrial machines where not much space is provided between components. Although in many cases, a manual wrench will suffice, it will be more difficult and time consuming since a manual wrench does not have a ratcheting mechanism. Thus, after each turn of the wrench, the wrench must be removed and placed in a different position for the next turn

### SUMMARY

An open-ended ratchet wrench includes a wrench body, an open-ended wrench head coupled on a first distal end of the wrench body, and a handle disposed on a second distal end of the wrench body. The open-ended ratchet wrench includes a ratchet mechanism such that the open-ended wrench head is capable of continuous rotational motion in only one direction. The wrench head can be easily removed and replaced by another such wrench head of a different size from a set of wrench heads. The tool is particularly useful in places where a socket wrench would not fit.

### BRIEF DESCRIPTION OF THE DRAWINGS

FIG. 1 shows a perspective view of an open-ended ratchet wrench, according to example embodiments of the disclosure.

FIGS. 2A-C show the open-ended ratchet wrench turning a nut, according to example embodiments of the disclosure.

FIG. 3 shows an exploded view of the open-ended ratchet wrench, according to example embodiments of the disclosure.

FIGS. 4A and 4B show partially assembled views of the open-ended ratchet wrench, according to example embodiments of the disclosure.

FIGS. 5A and 5B show perspective views of the open-ended ratchet wrench in locked and unlocked configurations, respectively, according to example embodiments of the disclosure.

FIG. 6 shows the open-ended ratchet wrench in an unlocked configuration allowing access to a removable open wrench head, according to example embodiments of the disclosure.

FIGS. 7A and 7B show perspective views of an extended open wrench head useable in conjunction with the open-ended ratchet wrench, according to example embodiments of the disclosure.

FIG. 8 shows a perspective view of a double-sided extended open wrench head useable in conjunction with the open-ended ratchet wrench, according to example embodiments of the disclosure.

FIG. 9 shows a perspective view of a star-shaped socket wrench head, according to example embodiments of the disclosure.

FIG. 10 shows a view of the star-shaped socket wrench head separated into two pieces.

### DETAILED DESCRIPTION OF EXAMPLE EMBODIMENTS

Example embodiments of the disclosure now will be described more fully hereinafter with reference to the accompanying drawings, in which example embodiments are shown. The concepts discussed herein may, however, be embodied in many different forms and should not be construed as limited to the example embodiments set forth herein; rather, these embodiments are provided so that this disclosure will be thorough and complete, and will fully convey the scope to those of ordinary skill in the art.

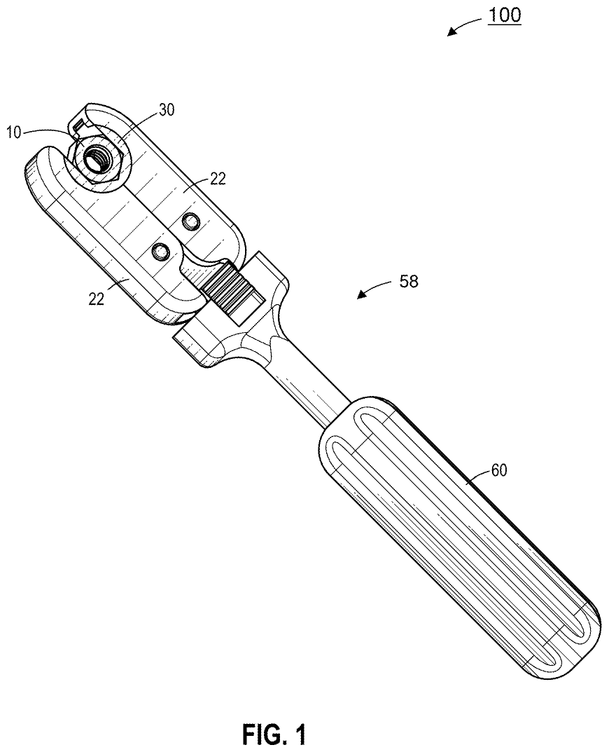

Referring to FIG. 1, a perspective view of an open-ended ratchet wrench 100, according to example embodiments of the disclosure, is illustrated. As shown, the open-ended ratchet wrench 100 includes a wrench body 58, an open-ended wrench head 30 disposed on a first distal end of the wrench body 58, and a handle 60 disposed on a second distal end of the wrench body 58. The wrench body includes a pair of clamshells 22 that enclose a plurality of components including a ratcheting mechanism that permits continuous rotational motion of the open-ended wrench head 30 in only one direction while preventing rotational motion of the open-ended wrench head 30 in the opposite direction, while allowing the handle 60 to be repositioned for application of further rotational motion in the same direction. In the illustrated embodiment, torque would be applied to the nut 10 by pulling the handle 60, and pushing the handle would not rotate the nut 10 but rather reposition the handle 60 for another turn. Advantageously, during usage the open-ended wrench head 30 does not have to be removed from the nut 10. Furthermore, a dual ratcheting mechanism does not have to be provided since using the open-ended ratchet wrench 100 to rotate the nut 10 in the opposite direction can be accomplished by simply turning the open-ended ratchet wrench 100 over and using the other side.

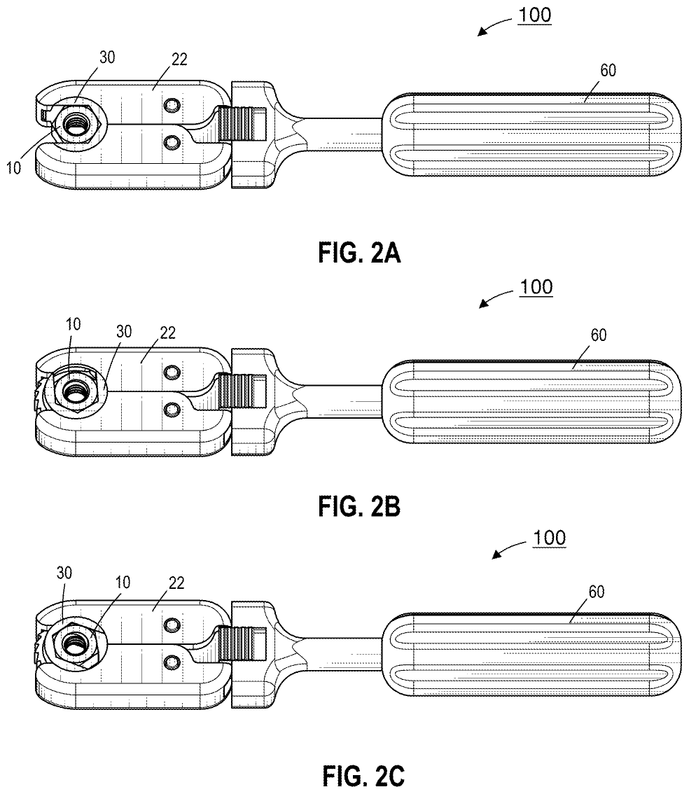

FIGS. 2A-C show the open-ended ratchet wrench 100 turning the nut 10, according to example embodiments of the disclosure. As illustrated in FIG. 2A, the open-ended ratchet wrench head 30 initially engages the nut 10. FIGS. 2B and 2C illustrate rotations of the open-ended ratchet wrench head 30 (and thereby the nut 10). It is to be appreciated that the open-ended ratchet wrench head 30 is configured to rotate around until the nut 10 is finally tightened (or untightened, as the case may be).

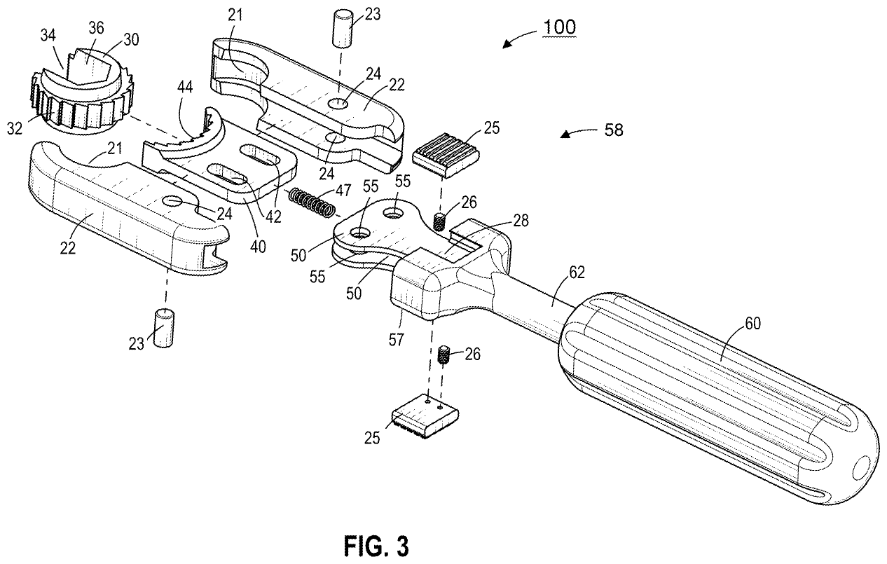

FIG. 3 shows an exploded view of the open-ended ratchet wrench 100, according to example embodiments of the disclosure. As shown, the open-ended ratchet wrench 100 includes a wrench frame 57 having substantially identical first and second prongs 50 extending from one side. The pair of prongs 50 are arranged such that the first prong 50 is disposed parallel to the second prong 50, with a void in between. Each of the prongs 50 includes a pair of circular holes 55. The placement of the circular holes 55 of the first prongs 50 correspond to the circular holes 55 of the second prong 50. On the opposite side of the wrench frame 57 is disposed a handle connector 62 allowing the handle 60 to be connected thereto. On front and back sides of the wrench frame 57, respectively, are slots 28 each accommodating a slide button 25. Further, each of the slide buttons 25 is provided with a detent 26 to allow a degree of resistance to sliding the respective slide button 25.

The open-ended ratchet wrench 100 further includes a ratcheting member 40, as shown. The ratcheting member 40 includes on one side a plurality of ratchet grooves 44 that are arranged in a circular arc. On the opposite side is flat portion that has a width sufficient to fit between the prongs 50. A compression spring 47 is fitted between the flat portion of the ratcheting member 40 and the frame 57. Still further, the open-ended ratchet wrench head 20) 30 is provided. The open-ended ratchet wrench head 30 includes on one end an opening 34 shaped to fit a bolt head or nut of a specific dimension. On the other end of the open-ended ratchet wrench head 30 ratchet gears 32 are arranged in a circular arc extending the entire length along the periphery (up to but excluding the opening 34). The ratchet gears 32 are structured to fit into the ratchet grooves 44. Each of the ratchet gears 32 has a slope substantially greater on one side than the other, such that when fitted into corresponding ratchet grooves 44, rotational motion is permitted in the direction of the side with the greater slope only. It is to be understood that the open-ended wrench head 30 is a replaceable element of the device, and a set of such open-ended ratchet wrench heads 30 can include a plurality of such wrench heads having different sizes or types. These wrench heads can include standard (or non-standard) sizes measured in any suitable measuring scheme (e.g., inches, metric) and type (e.g., hexagonal, square).

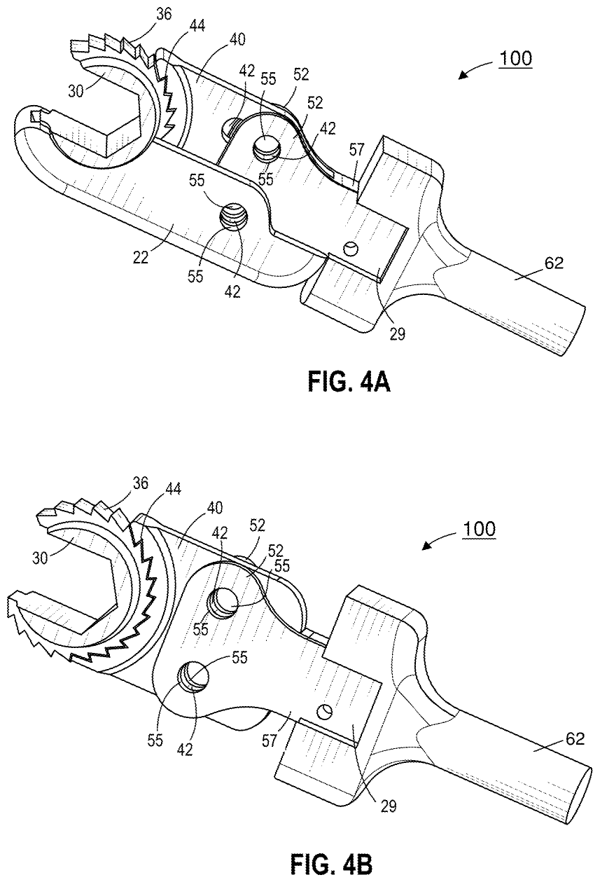

A pair of clamshells 22 are provided to enclose the device. The clamshells 22 align and guide the ratcheting member 40, the open-ended ratchet wrench head 30, and the frame 57. More particularly, the flat portion of the ratcheting member 40 mentioned earlier is sandwiched between the prongs 50 and the open-ended ratchet wrench head 30 is connected with the ratcheting member 40 such that some of the ratchet gears 32 interlock with at least some of the ratchet grooves 44. The clamshells 22 can be fitted with dowels 23 or the like. Each of the dowels 23 is inserted into a respective first clamshell hole 24. The dowels then pass through a circular hole 55 of the first prong 50, a slot hole 42 of the ratcheting member 40, a circular hole 55 of the second prong 50, and a second clamshell hole 24 (on the other side of clamshell 22). This arrangement is most clearly shown in FIGS. 4A and 4B, which illustrate partially assembled views. As will be described in greater detail shortly, this structure allows the clamshells 22 to be easily opened and closed.

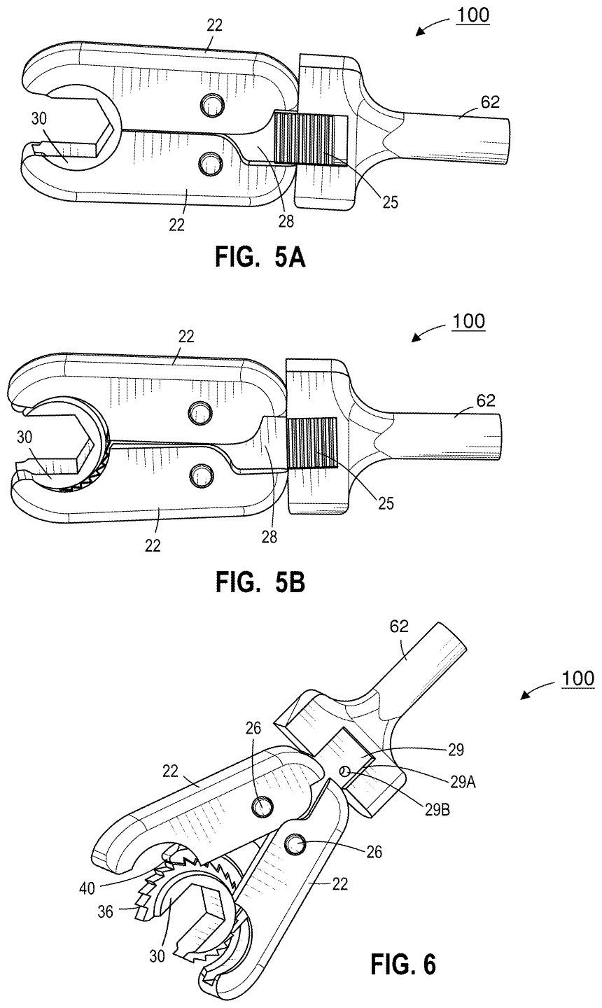

FIGS. 5A and 5B show perspective views of the open-ended ratchet wrench 100 in locked and unlocked configurations, respectively, according to example embodiments of the disclosure. As shown in FIG. 5A, the slide button 25 is pushed forward so that it effectively blocks the clamshells 22 from pivoting open. However, as shown in FIG. 5B, with the slide button pulled down, the clamshells are able to pivot open. FIG. 6 illustrates the clamshells in the open position. In this position, the open-ended ratchet wrench head 30 can be removed in order to remove it from the nut or bolt head or to replace the open-ended ratchet wrench head 30 with another one of a different size, for example.

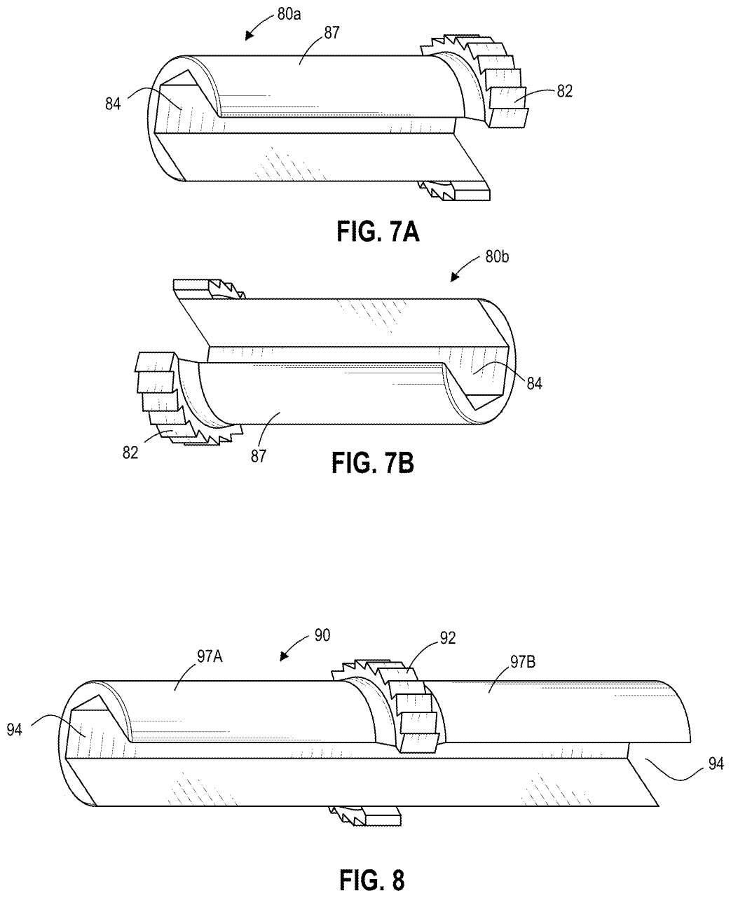

FIG. 7A shows a perspective view of an extended open-ended ratchet wrench head 80a useable in conjunction with the open-ended ratchet wrench 100, according to an example embodiment of the disclosure. The open-ended ratchet wrench head 80a is similar to the open-ended ratchet wrench head 30, the difference being that the open-ended ratchet wrench head 80 includes an extension 87 that can extend the reach of the open-ended ratchet wrench head 80a. For example, the extension 87 could be four inches in length allowing the device to reach difficult to reach fasteners. The ratchet gear 82 has the same structure as the ratchet gear 32. The opening 84 is similar to the opening 34 except that it is extended by the extension 87.

FIG. 7B shows a perspective view of an extended open-ended ratchet wrench head 80b useable in conjunction with the open-ended ratchet wrench 100 for the turning in the opposite direction from the open-ended ratchet wrench head 80a, according to an example embodiment of the disclosure. The open-ended ratchet wrench head 80b is substantially the same as the open-ended ratchet wrench head 80a, the difference being that the open-ended ratchet wrench head 80b includes an extension 87b that can extend the reach of the open-ended ratchet wrench head 80b for the opposite turning direction from the open-ended ratchet wrench head 80a.

FIG. 8 shows a perspective view of a double-sided open-ended ratchet wrench head 90 useable in conjunction with the open-ended ratchet wrench 100, according to an example embodiment of the disclosure. The double-sided open-ended ratchet wrench head 90 includes a left extension 97A and a right extension 97B that extend the open-ended ratchet wrench head 90 in two directions. The ratchet gear 92 has the same structure as the ratchet gear 82. The openings 94 are similar to the opening 84 except that there are two of them, as shown. It is to be understood that the open-ended ratchet wrench head 90 includes dual wrench heads which allows a counter sunk bolt head to be turned in either direction, essentially combining the extended open-ended ratchet wrench heads 80a and 80b.

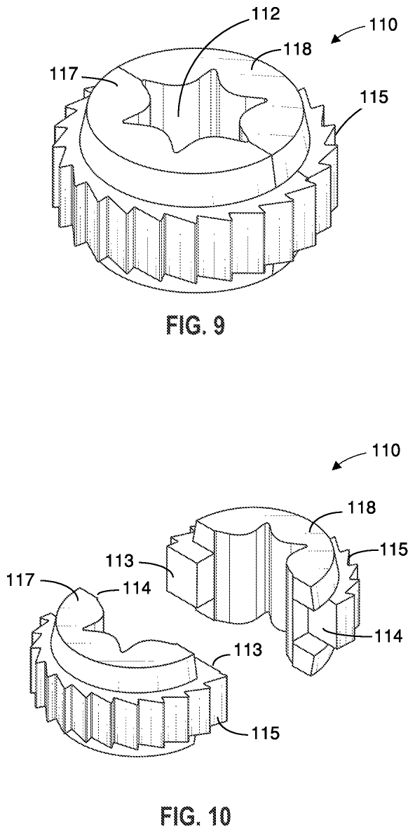

FIG. 9 shows a perspective view of a ratchet wrench head 110, according to another example embodiment of the disclosure. The illustrated open-ended ratchet wrench head 110 is a socket-style ratchet wrench head that can be used in place of the open-ended ratchet wrench head 30. As shown, the ratchet wrench head 110 includes a star-shaped socket 112 (e.g., an E-Torx socket) that includes six points. It is to be understood that another shaped socket (e.g., square, hexagonal) could be used. As shown, the ratchet wrench head 110 includes ratchet grooves 115 that extend entirely around the circumference.

As shown in FIG. 10, the ratchet wrench head 110 includes a first wrench head portion 117 and a second wrench head portion 118. The first wrench head portion 117 and the second wrench head portion 118 can interconnect to form the complete device as illustrated in FIG. 9. Although in the illustrated embodiment, the first wrench head portion 117 and the second wrench head portion 118 are connected by fitting male connectors 113 to female connectors 114, it is to be understood that other connection structures could be used. Further, it is to be understood that in some embodiments, the ratchet wrench head 110 comprises a unitary body. That is, the ratchet wrench head 110 would comprise a single piece rather than have separate portions that fit together.

Although the features, functions, components, and parts have been described herein in accordance with the teachings of the present disclosure, the scope of coverage of this patent is not limited thereto. On the contrary, this patent covers all embodiments of the teachings of the disclosure that fairly fall within the scope of permissible equivalents.

Conditional language, such as, among others, “can,” “could,” “might,” or “may,” unless specifically stated otherwise, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. An open-ended ratchet wrench, comprising:
a wrench body;
an open-ended wrench head coupled on a first distal end of the wrench body; and
a handle disposed on a second distal end of the wrench body;
wherein the open-ended wrench head is capable of continuous rotational motion in only one direction.

2. The open-ended ratchet wrench of claim 1, wherein the open-ended wrench includes a ratcheting mechanism that permits the continuous rotational motion of the open-ended wrench head in only the one direction while preventing rotational motion of the open-ended wrench head in the opposite direction but allowing the handle to be repositioned for application of further rotational motion in the same direction.

3. The open-ended ratchet wrench of claim 1, wherein the open-ended wrench head includes an open side conforming to a particular sized fastener head.

4. The open-ended ratchet wrench of claim 1, wherein the open-ended wrench head incudes a plurality of ratchet gears along a curved periphery thereof.

5. The open-ended ratchet wrench of claim 4, wherein the ratchet gears of the open-ended wrench head are fitted into a plurality of ratchet grooves to form a ratcheting mechanism.

7. The open-ended ratchet wrench of claim 5, wherein each of the ratchet gears have a slope substantially greater on one side than the other, such that the rotational motion is permitted in the direction of the side with the greater slope only.

6. The open-ended ratchet wrench of claim 1, wherein the open-ended wrench head is removable.

7. The open-ended ratchet wrench of claim 1, wherein the open-ended wrench head is capable of 360-degree rotation.

8. The open-ended ratchet wrench of claim 1, wherein the open-ended wrench head is replaceable by another open-ended wrench head having dimensions to fit a different sized nut or bolt.

9. The open-ended ratchet wrench of claim 1, wherein the wrench body includes a clamshell body.

10. The open-ended ratchet wrench of claim 9, wherein the wrench body further includes a sliding button.

11. The open-ended ratchet wrench of claim 10, wherein sliding the sliding button in a first direction locks the clamshell body.

12. The open-ended ratchet wrench of claim 11, wherein sliding the sliding button in a second direction unlocks the clamshell body allowing the open-ended wrench head to be released.

13. The open-ended ratchet wrench of claim 1, wherein the open-ended ratchet wrench head conforms to a hexagonal fastener head.

14. The open-ended ratchet wrench of claim 1, wherein the open-ended ratchet wrench head includes an extender.

15. The open-ended ratchet wrench of claim 1, wherein the open-ended ratchet head includes a dual wrench heads.

16. A ratchet wrench, comprising:
a wrench body;
a wrench head coupled on a first distal end of the wrench body; and
a handle disposed on a second distal end of the wrench body;
wherein the open-ended wrench head is capable of continuous rotational motion in only one direction.

17. The ratchet wrench of claim 16, wherein the wrench head is an open-ended wrench head.

18. The ratchet wrench of claim 17, wherein the wrench head is socket wrench head.

19. The ratchet wrench of claim 18, wherein the socket wrench head includes a star-shaped socket.

20. The ratchet wrench of claim 18, wherein the socket wrench head includes a first wrench head portion and a second wrench head portion that are capable of interlocking to form a complete socket wrench head.
